(19) United States
(12) Patent Application Publication
(10) Pub. No.: US 2026/0270349 A1
(43) Pub. Date: Sep. 10, 2026

(54) IMAGE INFORMATION SYSTEM

(71) Applicant: SHARP KABUSHIKI KAISHA, Sakai City (JP)

(72) Inventor: Kyohya KAWANO, Sakai City (JP)

(21) Appl. No.: 19/554,811

(22) Filed: Mar. 3, 2026

(30) Foreign Application Priority Data
Mar. 4, 2025 (JP) 2025-033872

(51) Int. Cl. H04N 1/00

(52) U.S. Cl. CPC H04N 1/00225; H04N 1/00217

(57) ABSTRACT

An image information system includes a terminal that transmits, to equipment in a local area network, an image display request via an image transfer service provided on an Internet, a tunneling server that establishes a tunnel connection between the local area network and the Internet, and an image generation terminal that is provided in the local area network, converts the image display request received from the terminal via the image transfer service into a request in accordance with a predetermined communication protocol and transmits the request to the equipment, and, on one hand, generates image information based on a response in accordance with the communication protocol received from the equipment and transmits the image information to the terminal via the image transfer service.

### FIELD OF THE INVENTION

The disclosure relates to an image information system.

### BACKGROUND ART

In the related art, a technique is known in which equipment connected via a dedicated line such as a local area network (LAN) is accessed from an external terminal, and an operation screen of the equipment is displayed on the terminal for operation.

As such a technique, for example, there has been proposed a technique of an image forming apparatus in which a remote operation screen, which is a screen for operating an image forming apparatus, is displayed on an operation terminal, print settings and an execution instruction are accepted from the operation terminal via the remote operation screen, and when the image forming apparatus accepts a print execution instruction through a screen of an application different from an application that accepted a display request for the remote operation screen, the image forming apparatus prints an image acquired with the print settings accepted through the remote operation screen.

Further, a technique for operating a Multifunctional Peripheral (MFP) in a LAN from a terminal on the Internet has also been proposed.

In this technique, first, a tunneling PC within the LAN and a reverse proxy server on the Internet side are connected via WebSocket communication or always-on (bidirectional) Hyper Text Transfer Protocol (HTTP) communication. Next, a terminal connects to the reverse proxy server from a web browser of the terminal and transmits a request via HTTP. The reverse proxy server transfers the request to the MFP via the tunneling PC. Then, the MFP transmits a requested image to the web browser in Hyper Text Markup Language (HTML), so that the web browser can interpret the content of the HTML response and display it on a screen.

With such a technique, a user can access the MFP from a terminal on the Internet and display an operation screen of the MFP on a web browser of the terminal to perform an operation.

### SUMMARY

### Technical Problem

However, in the related art, in which equipment in a LAN is accessed from a terminal on the Internet via a reverse proxy server to display its operation screen, there is a problem in that image information of a URL within the LAN displayed on the operation screen of the equipment cannot be displayed, since a URL that is valid only within the LAN cannot be accessed.

The disclosure has been made in consideration of the above circumstances, and an object thereof is to provide an image information system capable of displaying image information of a URL that is valid only in a LAN when the equipment within the LAN is accessed from a terminal on the Internet.

### Solution to Problem

The disclosure provides an image information system including a terminal that transmits, to equipment in a local area network, an image display request via an image transfer service provided on an Internet, a tunneling server that establishes a tunnel connection between the local area network and the Internet, and an image generation terminal that is provided in the local area network, converts the image display request received from the terminal via the image transfer service into a request in accordance with a predetermined communication protocol and transmits the request to the equipment, and, on one hand, generates image information based on a response in accordance with the communication protocol received from the equipment and transmits the image information to the terminal via the image transfer service.

### Advantageous Effects of Disclosure

According to the disclosure, an image generation terminal provided in a local area network converts an image display request received from a terminal on the Internet into a request in accordance with a predetermined communication protocol and transmits the request to equipment, and, on one hand, generates image information based on a response in accordance with the communication protocol received from the equipment and transmits the image information to the terminal via an image transfer service, thereby realizing an image information system capable of displaying image information of a URL that is valid only within the LAN when the equipment within the LAN is accessed from the terminal on the Internet.

### BRIEF DESCRIPTION OF THE DRAWINGS

FIG. 1 is an explanatory diagram illustrating an example of a configuration of an image information system according to the disclosure.

FIG. 2 is an explanatory diagram illustrating a schematic configuration of a digital multifunction peripheral illustrated in FIG. 1.

FIG. 3 is an explanatory diagram illustrating a schematic configuration of a user terminal illustrated in FIG. 1.

FIG. 4 is an explanatory diagram illustrating a schematic configuration of an image generation terminal illustrated in FIG. 1.

FIG. 5 is a flowchart illustrating an outline of processing of the image information system illustrated in FIG. 1.

FIG. 6 is a sequence diagram illustrating processing corresponding to establishment of a tunnel connection and start of operation of the digital multifunction peripheral among the processing of the image information system illustrated in FIG. 5.

FIG. 7 is a sequence diagram illustrating processing corresponding to operation (click operation) of a screen of the digital multifunction peripheral among the processing of the image information system illustrated in FIG. 5.

FIGS. 8A and 8B are explanatory diagrams illustrating, respectively, an example of a mouse click operation on a screen of the digital multifunction peripheral displayed on a display of a user terminal and an example of a display result thereof in an image information system of the related art using a technique such as a reverse proxy.

FIGS. 9A and 9B are explanatory diagrams illustrating, respectively, an example of a mouse click operation on a screen of the digital multifunction peripheral displayed on a display of a user terminal and an example of a display result thereof in the image information system illustrated in FIG. 1.

### DESCRIPTION OF EMBODIMENTS

In the disclosure, a “terminal” is, for example, a terminal such as a personal computer (PC) or a tablet, or a mobile terminal such as a smartphone.

“Equipment” is, for example, equipment in a local area network such as a copier or a multifunction peripheral, or an MFP including functions other than copying, a television, a DVD recorder, a personal computer (PC), an electronic whiteboard, or the like.

An “image transfer service” is a service provided by a cloud server or the like, and transmits a request from a terminal to equipment via the Internet and transfers an image received from the equipment to the terminal.

A “tunneling server” is a server that establishes a virtual direct line (tunnel) connection with the image transfer service when attempting transmission and reception of data between equipment in a local area network and the image transfer service on the Internet.

Furthermore, preferred aspects of the disclosure will be described.

In the image information system of the disclosure, when the terminal detects a click operation on a display image based on the image information received from the image generation terminal, the terminal transmits position coordinates of the click operation to the image generation terminal via the image transfer service, and the image generation terminal converts the position coordinates of the click operation received from the terminal into a request in accordance with the communication protocol and transmits the request to the equipment, and, on the other hand, generates image information based on a response in accordance with the communication protocol received from the equipment and transmits the image information to the terminal via the image transfer service, and such an operation may be performed.

In this manner, when a terminal detects a click operation on a display image based on image information received from an image generation terminal, the terminal transmits position coordinates of the click operation to the image generation terminal via an image transfer service, and the image generation terminal converts the position coordinates of the click operation received from the terminal into a request in accordance with a communication protocol and transmits the request to equipment, and, on the other hand, generates image information based on a response in accordance with the communication protocol received from the equipment and transmits the image information to the terminal via the image transfer service, thereby realizing an image information system capable of displaying image information of a URL that is valid only in a LAN when the equipment within the LAN is accessed from a terminal on the Internet.

In the image information system of the disclosure, the communication protocol may be HTTP.

In this manner, an image generation terminal provided in a local area network converts an image display request received from a terminal on the Internet into an HTTP request and transmits the HTTP request to equipment, and, on the other hand, generates image information based on an HTTP response received from the equipment and transmits the image information to the terminal via an image transfer service, thereby realizing an image information system capable of displaying image information of a URL that is valid only within the LAN when the equipment within the LAN is accessed from the terminal on the Internet.

In the image information system of the disclosure, the image generation terminal may generate image information based on a response when there is a change in the response in accordance with the communication protocol received from the equipment.

In this manner, when there is a change in a response in accordance with the communication protocol received from the equipment, the image generation terminal generates image information based on the response, thereby realizing an image information system capable of displaying image information of a URL that is valid only within the LAN when the equipment within the LAN is accessed from a terminal on the Internet.

In the image information system of the disclosure, the image generation terminal may be provided in the equipment or the tunneling server.

In this manner, by the image generation terminal being provided in the equipment or the tunneling server, it is possible to realize an image information system capable of displaying image information of a URL that is valid only within the LAN when equipment within the LAN is accessed from a terminal on the Internet, without separately providing an image generation terminal.

Hereinafter, the disclosure will be described in further detail using the drawings. Note that the following description is illustrative in all aspects and it should not be understood as limiting the disclosure.

### Embodiment 1

Schematic Configuration of Image Information System 100

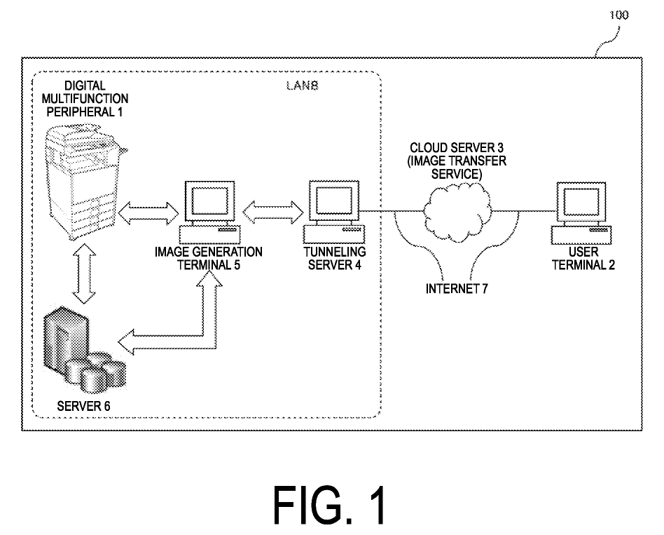

A schematic configuration of an image information system 100 according to Embodiment 1 of the disclosure will be described based on FIGS. 1 to 4.

FIG. 1 is an explanatory diagram illustrating an example of a configuration of the image information system 100 according to the disclosure.

In the image information system 100 of the disclosure, a user terminal 2 is connected to a digital multifunction peripheral 1 provided in a local area network (LAN 8) via the Internet 7.

As illustrated in FIG. 1, within the LAN 8, the digital multifunction peripheral 1 is connected to an image generation terminal 5 and a server 6, and the image generation terminal 5 is connected to the tunneling server 4.

The user terminal 2 is connected to a cloud server 3 via the Internet 7, and the cloud server 3 is connected to the tunneling server 4.

The digital multifunction peripheral 1 is an image forming apparatus such as a multifunction machine or an MFP that digitally processes image data and has a copy function, a printer function, a scanner function, and a facsimile function.

The user terminal 2 is a terminal such as a personal computer (PC) or a tablet, or a mobile terminal such as a smartphone.

The user terminal 2 transmits and receives various requests and image data to and from the digital multifunction peripheral 1 via the cloud server 3, the tunneling server 4, and the image generation terminal 5.

The cloud server 3 is connected to the tunneling server 4 via WebSocket communication or always-connected (bidirectional) Hyper Text Transfer Protocol (HTTP) communication. When receiving a request via HTTP from a Web browser of the user terminal 2, the cloud server transfers the request to the image generation terminal 5 via the tunneling server 4. On the other hand, when receiving image information from the image generation terminal 5, the cloud server provides an image transfer service that transfers the image information to the user terminal 2.

The tunneling server 4 establishes a virtual direct line (tunnel) connection with an image transfer service provided by the cloud server 3 by using a Virtual Private Network (VPN). By transmitting and receiving data between the cloud server 3 and the image generation terminal 5 through the tunnel connection, eavesdropping and tampering from outside are prevented.

The image generation terminal 5 converts a request received from the user terminal 2 via the cloud server 3 and the tunneling server 4 into the HTTP request and transmits the request to the digital multifunction peripheral 1.

On the other hand, the image generation terminal 5 converts a HTTP response (HTML data) received from the digital multifunction peripheral 1 into image data and transmits the image data to the tunneling server 4.

The server 6 is a terminal that is connected to the digital multifunction peripheral 1 and the image generation terminal 5 within the LAN 8, and is capable of transmitting and receiving various data including image data to and from the digital multifunction peripheral 1 and the image generation terminal 5.

The Internet 7 is a wide area network (WAN) that interconnects the user terminal 2, the cloud server 3, and the tunneling server 4.

The LAN 8 is a local area network that connects the digital multifunction peripheral 1, the tunneling server 4, the image generation terminal 5, and the server 6 to each other.

Schematic Configuration of Digital Multifunction Peripheral 1

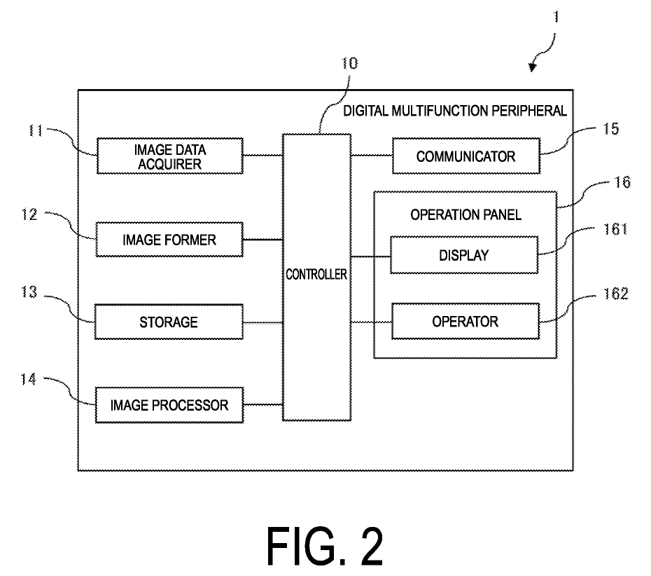

FIG. 2 is an explanatory diagram illustrating a schematic configuration of the digital multifunction peripheral 1 illustrated in FIG. 1.

As illustrated in FIG. 2, the digital multifunction peripheral 1 includes a controller 10, an image data acquirer 11, an image former 12, a storage 13, an image processor 14, a communicator 15, and an operation panel 16.

Hereinafter, each component of the digital multifunction peripheral 1 will be described.

The controller 10 collectively controls the digital multifunction peripheral 1 and includes at least one central processing unit (CPU), at least one random access memory (RAM), at least one read only memory (ROM), and various interface circuits.

The controller 10 monitors and controls detection of each sensor and all loads such as a motor, a clutch, and the operation panel 16 to control overall operations of the digital multifunction peripheral 1.

The image data acquirer 11 is a part that acquires image data received from the user terminal 2 via the cloud server 3, the tunneling server 4, and the image generation terminal 5.

The image former 12 is a part that prints an image based on image data acquired by the image data acquirer 11 and processed by the image processor 14 onto paper.

The storage 13 is an element or a storage medium that stores information necessary to enable various functions of the digital multifunction peripheral 1, control programs, and the like. For example, a semiconductor element such as a RAM or a ROM or a storage medium such as a hard disk, a flash storage, or a Solid State Drive (SSD) is used.

Note that the program and the data may be stored in different devices, such as by configuring an area for storing data in a hard disk drive and an area for storing programs in a flash storage.

The image processor 14 is a part that converts image data input from the image data acquirer 11 into appropriate electrical signals and performs processing such as enlargement or reduction to make it suitable for output based on the analysis results of job instructions for printing or the like acquired from the user terminal via the communicator 15 or job instructions for printing or the like input from an operator 162.

The communicator 15 is a part that performs communication with the user terminal 2 via the cloud server 3, the tunneling server 4, and the image generation terminal 5, and communication with the server 6 via the LAN 8, and transmits and receives various data.

The operation panel 16 includes a display panel composed of a liquid crystal panel or the like, and a touch panel of a capacitive touch system or the like that is overlaid and placed on the display panel and detects a position touched with a finger, and includes a display 161 and the operator 162.

The display 161 is a part that displays various types of information.

The display 161 is composed of, for example, a CRT display, a liquid crystal display, an EL display, or the like, and is a display apparatus such as a monitor or a line display for displaying electronic data such as a processing status processed by an operating system or application software.

The controller 10 displays the operation and status of the digital multifunction peripheral 1 through the display 161.

The operator 162 is an interface for operating the digital multifunction peripheral 1 and accepts commands from the user.

The operator 162 does not necessarily entirely support touch panel operation, and a part or all of the operator 162 may be composed of physical keys independent of the display 161.

### Schematic Configuration of User Terminal 2

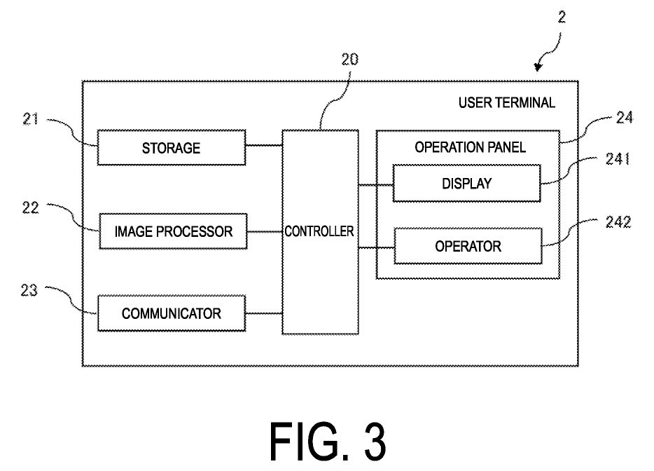

FIG. 3 is an explanatory diagram illustrating a schematic configuration of the user terminal 2 illustrated in FIG. 1.

As illustrated in FIG. 3, the user terminal 2 includes a controller 20, a storage 21, an image processor 22, a communicator 23, and an operation panel 24.

Hereinafter, each component of the user terminal 2 will be described.

The controller 20 integrally controls the user terminal 2 and includes at least one CPU, at least one RAM, at least one ROM, various interface circuits, and the like.

The controller 20 performs monitoring and control of detection of each sensor and all loads such as an operator 242 or the like in order to control operations of the entire user terminal 2.

The storage 21 is an element or a storage medium that stores information necessary for implementing various functions of the user terminal 2, and control programs, or the like.

For example, a semiconductor device such as a RAM or a ROM or a storage medium such as a hard disk, a flash storage, or an SSD is used.

The storage 21 stores information related to jobs such as printing and data necessary for execution of the jobs, such as image data.

Note that the program and the data may be held in different devices to configure the region for holding data as a hard disk drive and the region for holding the program as a flash storage.

The image processor 22 is a part that converts the image data into an appropriate electric signal and processes the electrical signal suitably for output such as enlargement or reduction.

The communicator 23 is a part that performs communication with external equipment such as the cloud server 3 via a network, and transmits and receives instructions for jobs such as printing and document image data, or the like.

Further, the communicator 23 is a part that performs communication with the digital multifunction peripheral 1 via the cloud server 3, the tunneling server 4, and the image generation terminal 5, and transmits and receives various data.

The operation panel 24 includes a display panel composed of a liquid crystal panel or the like, and a touch panel of a capacitive touch system or the like that is overlaid and placed on the display panel and detects a position touched with a finger, and includes a display 241 and the operator 242.

The display 241 is a part that displays various types of information.

The display 241 is composed of, for example, a CRT display, a liquid crystal display, an EL display, or the like, and is a display apparatus such as a monitor or a line display for displaying electronic data such as a processing status processed by an operating system or application software.

The controller 20 displays the operation and status of the user terminal 2 through the display 241.

The operator 242 is an interface for operating the user terminal 2 and accepts commands from the user.

The display 241 and the operator 242 may include a display panel including a liquid crystal panel or the like and a capacitive touch panel that is disposed in a superimposed manner on the display panel and detects a position touched with a finger.

### Schematic Configuration of Image Generation Terminal 5

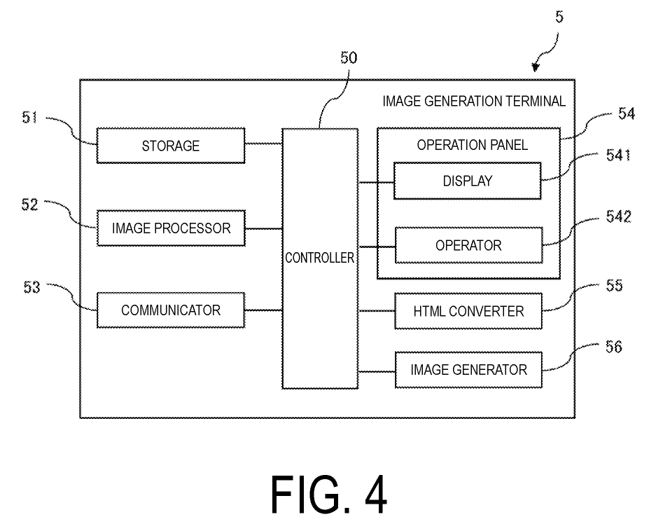

Next, a schematic configuration of the image generation terminal 5 will be described based on FIG. 4.

FIG. 4 is a block diagram illustrating a schematic configuration of the image generation terminal 5 illustrated in FIG. 1.

As illustrated in FIG. 4, the image generation terminal 5 includes a controller 50, a storage 51, an image processor 52, a communicator 53, an operation panel 54, an HTML converter 55, and an image generator 56.

Hereinafter, each component of the image generation terminal 5 will be described.

The controller 50 integrally controls the image generation terminal 5 and includes at least one CPU, at least one RAM, at least one ROM, various interface circuits, and the like.

The storage 51 is an element or a storage medium that stores information necessary to enable various functions of the image generation terminal 5, control programs, and the like. For example, a semiconductor device such as a RAM or a ROM or a storage medium such as a hard disk, a flash storage, or an SSD is used.

The image processor 52 is a part that performs processing to be suitable for output such as enlargement and reduction of an image displayed on a display 541 based on a command of an operator 542.

The communicator 53 is a part that performs communication with the digital multifunction peripheral 1 and the tunneling server 4 via the LAN 8, and transmits and receives various data such as image display requests and image data.

The operation panel 54 includes a display panel composed of a liquid crystal panel or the like, and a touch panel of a capacitive touch system or the like that is overlaid and placed on the display panel and detects a position touched with a finger, and includes a display 541 and the operator 542.

The display 541 is a part that displays various types of information.

The display 541 is composed of, for example, a CRT display, a liquid crystal display, an EL display, or the like, and is a display apparatus such as a monitor or a line display for displaying electronic data such as a processing status processed by an operating system or application software.

The controller 50 displays the operation and status of the image generation terminal 5 through the display 541.

The operator 542 is an interface for operating the image generation terminal 5 and accepts commands from the user.

The display 541 and the operator 542 may include a display panel including a liquid crystal panel or the like and a capacitive touch panel that is disposed in a superimposed manner on the display panel and detects a position touched with a finger.

The HTML converter 55 is a part that converts a request received from the user terminal 2 via the cloud server 3 and the tunneling server 4 into an HTTP request.

The image generator 56 is a part that converts an HTTP response (HTML data) received from the digital multifunction peripheral 1 or the server 6 into image data.

### Modification Example

As a modification example, the image information system 100 may have a configuration in which the image generation terminal 5 is not provided, and the HTML converter 55 and the image generator 56 are provided in the digital multifunction peripheral 1 or the tunneling server 4.

Processing of Image Information System 100 according to Embodiment 1 of Disclosure

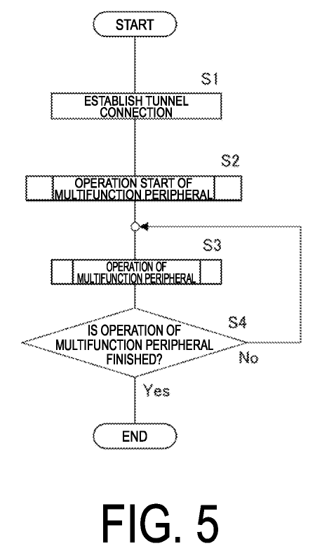

Next, a flow of processing of the image information system 100 according to Embodiment 1 of the disclosure will be described based on FIGS. 5 to 7.

FIG. 5 is a flowchart illustrating an outline of processing of the image information system 100 shown in FIG. 1.

In step S1 of FIG. 5, a tunnel connection is established between the cloud server 3 and the tunneling server 4 (step S1).

Next, after the tunnel connection is established, the operation of the digital multifunction peripheral 1 is started in step S2 (step S2).

Next, in step S3, the digital multifunction peripheral 1 is operated (step S3).

Next, in step S4, it is determined whether operation of the digital multifunction peripheral 1 has been completed (step S4).

When operation of the digital multifunction peripheral 1 has been completed (when the determination in step S4 is Yes), the processing ends.

On the other hand, when operation of the digital multifunction peripheral 1 has not been completed (when the determination in step S4 is No), the processing returns to step S3.

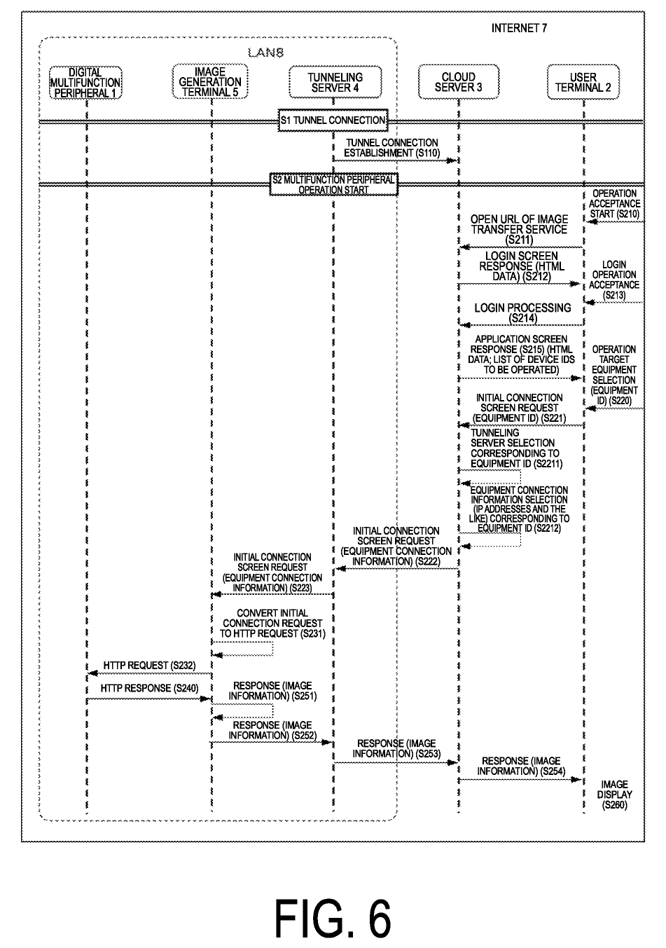

FIG. 6 is a sequence diagram illustrating processing corresponding to establishment of a tunnel connection and start of operation of the digital multifunction peripheral 1 among the processing of the image information system 100 illustrated in FIG. 5.

In FIG. 6, a case is assumed in which a user starts operation of the digital multifunction peripheral 1 via the image transfer service of the cloud server 3 in an image browsing application on a web browser of the user terminal 2.

### Establishment of Tunnel Connection

In step S110 of FIG. 6, the tunneling server 4 establishes a tunnel connection with the image transfer service of the cloud server 3. As a result, a path for subsequent bidirectional data communication between the cloud server 3 and the tunneling server 4 is secured.

### Operation Start of Digital Multifunction Peripheral 1

In step S210, when the image browsing application of the user terminal 2 receives, via the operator 242, acceptance of start of operation of the digital multifunction peripheral 1 (step S210), the URL of the image transfer service of the cloud server 3 is opened in step S211 (step S211).

In step S212, the image transfer service of the cloud server 3 responds with a login screen to the image browsing application of the user terminal 2 (step S212).

The login screen is composed of HTML data and is displayed on a screen of the image browsing application of the user terminal 2.

In step S213, a user ID and a password are input on the login screen of the image browsing application of the user terminal 2, and the operator 242 accepts a login operation (step S213).

In step S214, the image browsing application of the user terminal 2 transmits the input user ID and password to the image transfer service of the cloud server 3 and executes login processing (step S214).

When the login processing is successful, next, in step S215, the image transfer service of the cloud server 3 responds with an application screen to the image browsing application of the user terminal 2 (step S215).

The application screen is composed of HTML data and includes a list of device IDs to be operated.

In step S220, the image browsing application of the user terminal 2 accepts selection of the digital multifunction peripheral 1 from among a list of device IDs to be operated (step S220).

In step S221, the image browsing application of the user terminal 2 transmits a device ID of the selected digital multifunction peripheral 1 to the image transfer service of the cloud server 3 and requests an initial connection screen (step S221).

In step S2211, the image transfer service of the cloud server 3 selects the tunneling server 4 corresponding to the received device ID (step S2211).

In step S2212, the image transfer service of the cloud server 3 selects equipment connection information (such as an IP address) corresponding to the selected tunneling server 4 (step S2212).

In step S222, the image transfer service of the cloud server 3 transmits a request for an initial connection screen and equipment connection information to the selected tunneling server 4 (step S222).

In step S223, the tunneling server 4 transmits a request for an initial connection screen and equipment connection information to the image generation terminal 5 (step S223).

In step S231, the image generation terminal 5 converts the received request for an initial connection screen into an HTTP request (step S231). In this case, the HTTP request may be, for example, “GET/HTTP/1.1”.

In step S232, the image generation terminal 5 transmits an HTTP request to the digital multifunction peripheral 1 (step S232).

In step S240, the digital multifunction peripheral 1 returns an HTTP response (HTML data) to the image generation terminal 5 (step S240).

In step S251, the image generation terminal 5 converts the received HTML data into image information (step S251).

In step S252, the image generation terminal 5 transmits the converted image information as a response to the tunneling server 4 (step S252).

In step S253, the tunneling server 4 transmits the image information as a response to the image transfer service of the cloud server 3 (step S253).

In step S254, the image transfer service of the cloud server 3 transmits the image information as a response to the image browsing application of the user terminal 2 (step S254).

In step S260, the image browsing application of the user terminal 2 displays the received image information (step S260).

In this manner, in the image information system 100 of the disclosure, instead of an HTML response as in an image information system of the related art using a technique such as a reverse proxy, the image generation terminal 5 responds with image information resulting from interpretation of the HTML response, so that image information of a URL that is valid only within the LAN can also be displayed on the user terminal 2.

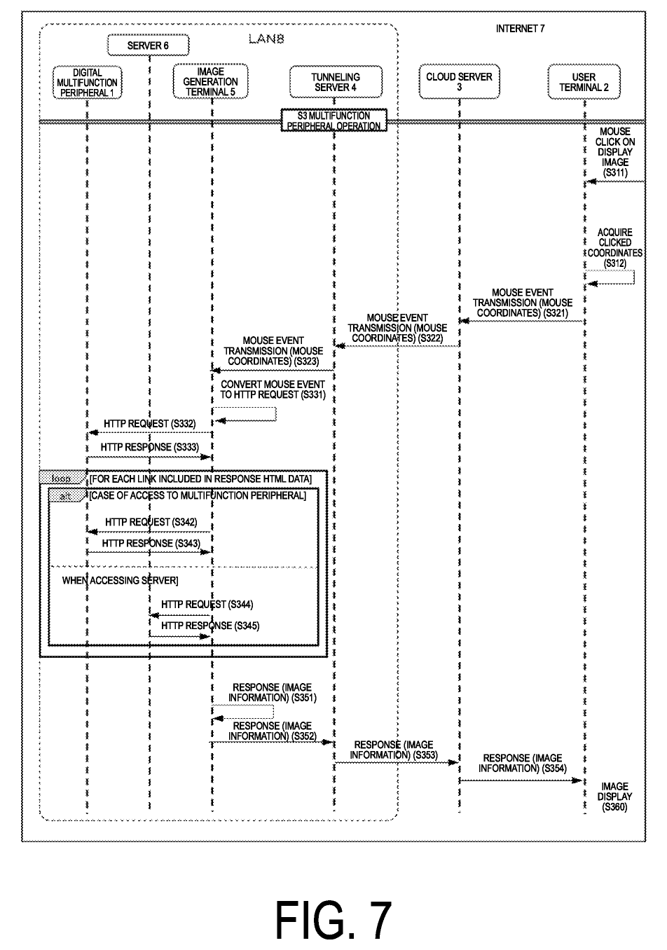

FIG. 7 is a sequence diagram illustrating processing corresponding to operation (click operation) of a screen of the digital multifunction peripheral 1 among the processing of the image information system 100 illustrated in FIG. 5.

### Operation of Digital Multifunction Peripheral 1

In step S311 of FIG. 7, the operator 242 detects that a mouse click operation has been performed on a displayed screen in the image browsing application of the user terminal 2 (step S311).

In step S312, the image browsing application of the user terminal 2 acquires coordinates at which a click operation has been performed on the screen (step S312).

In step S321, the image browsing application of the user terminal 2 transmits a mouse event (mouse coordinates) to the image transfer service of the cloud server 3 (step S321).

In step S322, the image transfer service of the cloud server 3 transmits a mouse event (mouse coordinates) to the tunneling server 4 (step S322).

In step S323, the tunneling server 4 transmits a mouse event (mouse coordinates) to the image generation terminal 5 (step S323).

In step S331, the image generation terminal 5 converts the received mouse event (mouse coordinates) into an HTTP request (step S331).

For example, when an image tag is displayed at the clicked coordinates, a URL specified by the tag is acquired by an HTTP request. In this case, the HTTP request may be, for example, “GET/page-x/HTTP/1.1”.

In step S332, the image generation terminal 5 transmits the HTTP request to the digital multifunction peripheral 1 (step S332).

In step S341, the digital multifunction peripheral 1 returns an HTTP response (HTML data) to the image generation terminal 5 (step S341).

Thereafter, different processing is performed depending on whether access is made to the digital multifunction peripheral 1 or to the server 6.

### When Accessing Digital Multifunction Peripheral 1

In step S342, the image generation terminal 5 transmits an HTTP request corresponding to a URL included in the response HTML data (step S342).

In step S343, the digital multifunction peripheral 1 returns an HTTP response (HTML data) to the image generation terminal 5 (step S343).

### When Accessing Server 6

In step S344, the image generation terminal 5 transmits an HTTP request to the server 6 (step S344).

In step S345, the server 6 returns an HTTP response (HTML data) to the image generation terminal 5 (step S345).

The processing of steps S342 to S345 is repeated for each link included in the response HTML data.

In step S351, the image generation terminal 5 generates a response image from the received HTML data (step S351).

In step S352, the image generation terminal 5 transmits the generated image information as a response to the tunneling server 4 (step S352).

In step S353, the tunneling server 4 transmits the image information as a response to the image transfer service of the cloud server 3 (step S353).

In step S354, the image transfer service of the cloud server 3 transmits the image information as a response to the image browsing application of the user terminal 2 (step S354).

In step S360, the image browsing application of the user terminal 2 displays the received image information (step S360).

The processing of steps S311 to S360 is repeated until operation of the digital multifunction peripheral 1 is completed.

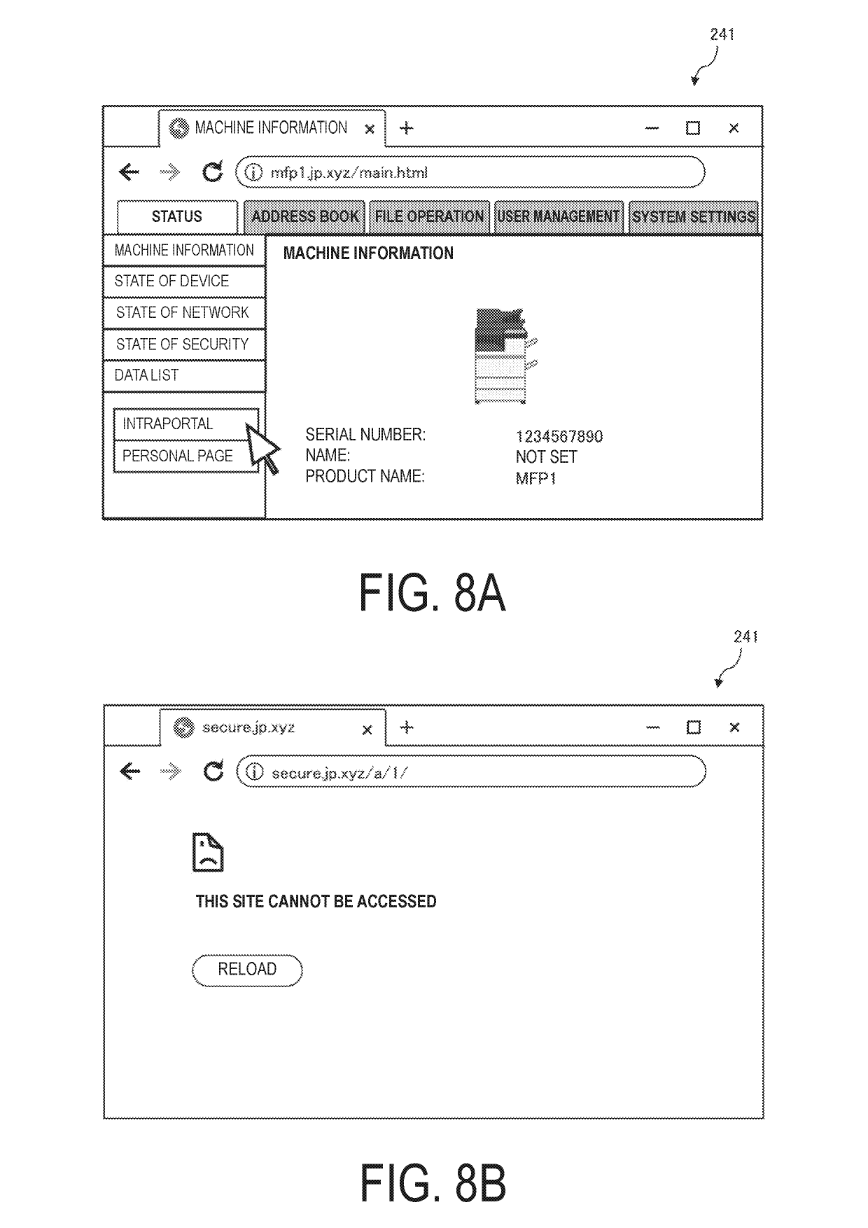

FIGS. 8A and 8B are explanatory diagrams illustrating, respectively, an example of a mouse click operation on a screen of the digital multifunction peripheral 1 displayed on the display 241 of the user terminal 2, and an example of a display result thereof, in an image information system of the related art using a technique such as a reverse proxy.

As illustrated in FIG. 8A, a case is assumed in which a screen of “Machine Information–MFP1” of the display 161 of the digital multifunction peripheral 1 (URL: “https://mfp1.jp.xyz/main.html”) is displayed on a screen of the image browsing application of the user terminal 2.

In this screen, even if a user clicks an “intra-portal” icon referring to a URL of the server 6 (“https://secure.jp.xyz/a/1”) that is valid only within the LAN 8, the file of the URL cannot be accessed.

Therefore, as illustrated in FIG. 8B, a message “This site cannot be accessed” is displayed on the user terminal 2, and the user cannot view an image of the URL of the server 6 (“https://secure.jp.xyz/a/1”).

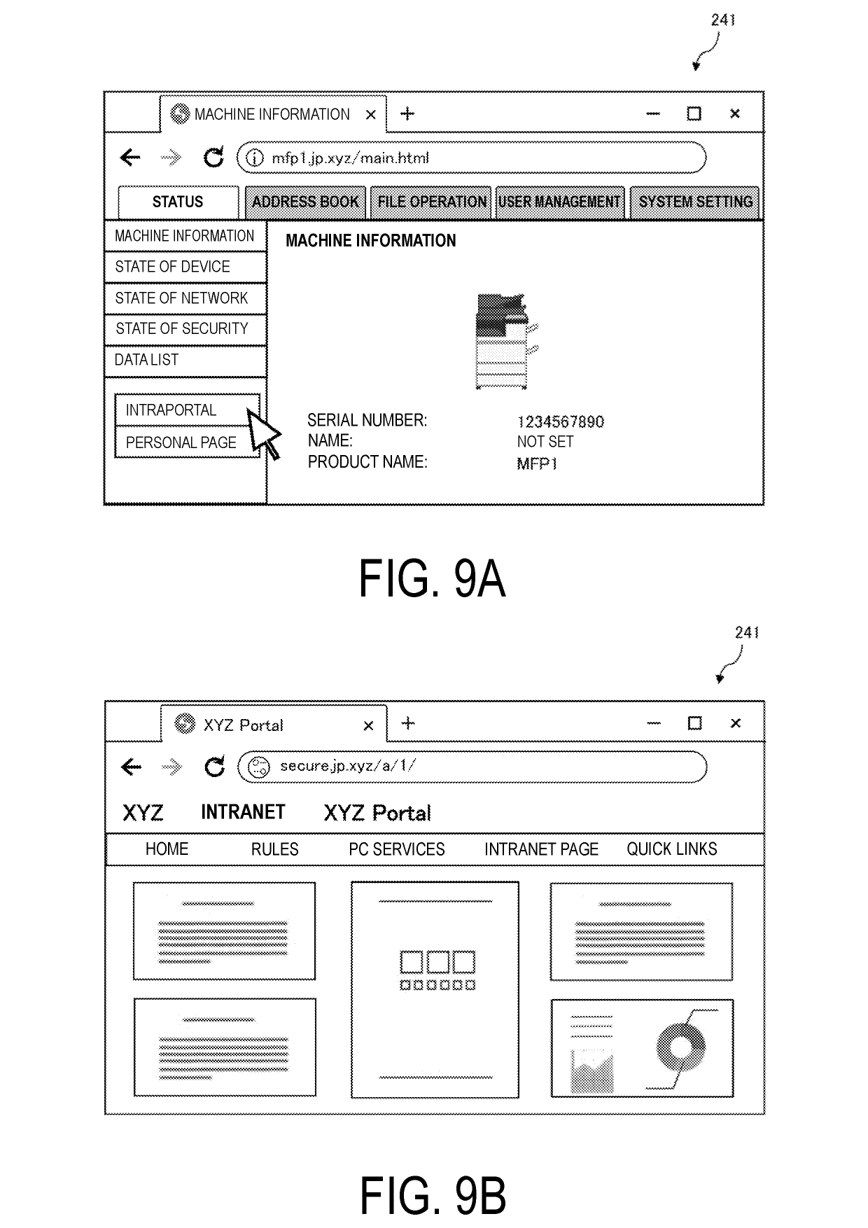

FIGS. 9A and 9B are explanatory diagrams illustrating, respectively, an example of a mouse click operation on a screen of the digital multifunction peripheral 1 displayed on the display 241 of the user terminal 2, and an example of a display result thereof, in the image information system 100 of the disclosure.

As illustrated in FIG. 9A, a case is assumed in which a screen of “Machine Information–MFP1” of the display 161 of the digital multifunction peripheral 1 (URL: “https://mfp1.jp.xyz/main.html”) is displayed on a screen of the image browsing application of the user terminal 2 according to Embodiment 1 of the disclosure.

In this screen, when a user clicks an “intra-portal” icon referring to a URL of the server 6 (“https://secure.jp.xyz/a/1”) that is valid only within the LAN 8, it becomes possible, as illustrated in FIG. 9B, to view an image of the URL of the server 6 (“https://secure.jp.xyz/a/1”).

In this manner, by converting an image display request received from the user terminal 2 into an HTTP request and transmitting the HTTP request to the digital multifunction peripheral 1, and, on the other hand, generating image information based on an HTTP response received from the digital multifunction peripheral 1 and transmitting the image information to the user terminal 2 via the image transfer service of the cloud server 3, it is possible to realize an image information system 100 capable of displaying image information of a URL of the server 6 that is valid only within the LAN 8, when the digital multifunction peripheral 1 within the LAN 8 is accessed from the user terminal 2 on the Internet 7.

### Modification Example

In the image information system 100 according to Embodiment 1 of the disclosure, the image generation terminal 5 is characterized in that, at a timing when an HTTP request is transmitted to the digital multifunction peripheral 1, an HTTP response (HTML data) received from the digital multifunction peripheral 1 is converted into image information, and the converted image information is transmitted as a response to the tunneling server 4.

On the other hand, as a modification, even when the image generation terminal 5 is not transmitting an HTTP request to the digital multifunction peripheral 1, if there is a change in a display image of the digital multifunction peripheral 1, the digital multifunction peripheral 1 may transmit an HTTP response (HTML data) to the image generation terminal 5.

In this manner, even when there is no request from the user terminal 2 to the digital multifunction peripheral 1, if there is a change in a display image of the digital multifunction peripheral 1, it becomes possible to display an updated image on the user terminal 2.

Preferred aspects of the disclosure include any combinations of the multiple aspects described above.

In addition to the aforementioned embodiments, various modifications of the disclosure are possible. It should not be understood that the modifications do not belong to the scope of the disclosure. The disclosure shall include meanings equivalent to the scope of the claims and all modifications within the scope.

### REFERENCE SIGNS LIST

1: Digital multifunction peripheral，2: User terminal，3: Cloud server, 4: Tunneling server, 5: Image generation terminal, 6: Server, 7: Internet, 8: LAN, 10, 20, 50: Controller, 11: Image data acquirer, 12: Image former, 13, 21, 51: Storage, 14, 22, 52: Image processor, 15, 23, 53: Communicator, 16, 24, 54: Operation panel, 161, 241, 541: Display, 162, 242, 542: Operator, 55: HTML converter, 56: Image generator, 100: Image information system

1. An image information system comprising:
a terminal that transmits an image display request to equipment in a local area network via an image transfer service provided on an Internet;
a tunneling server that establishes a tunnel connection between the local area network and the Internet; and
an image generation terminal that is provided in the local area network, converts the image display request received from the terminal via the image transfer service into a request in accordance with a predetermined communication protocol and transmits the request to the equipment, and, on one hand, generates image information based on a response in accordance with the communication protocol received from the equipment and transmits the image information to the terminal via the image transfer service.

2. The image information system according to claim 1, wherein
the terminal, when detecting a click operation on a display image based on the image information received from the image generation terminal, transmits position coordinates of the click operation to the image generation terminal via the image transfer service, and
the image generation terminal converts the position coordinates of the click operation received from the terminal into a request in accordance with the communication protocol and transmits the request to the equipment, and, on one hand, generates image information based on a response in accordance with the communication protocol received from the equipment and transmits the image information to the terminal via the image transfer service.

3. The image information system according to claim 1, wherein the communication protocol is HTTP.

4. The image information system according to claim 1, wherein the image generation terminal generates, when there is a change in a response in accordance with the communication protocol received from the equipment, image information based on the response.

5. The image information system according to claim 1, wherein the image generation terminal is provided in the equipment or the tunneling server.
